(19) United States
(12) Patent Application Publication
(10) Pub. No.: US 2012/0139325 A1
(43) Pub. Date: Jun. 7, 2012

(54) SYSTEM AND METHOD FOR TERRAIN ANALYSIS

(75) Inventors: Johan Norberg, Ornskoldsvik (SE); Eric Nettleton, Victoria (AU); Paul Thompson, New South Wales (AU); Hugh Durrant-Whyte, New South Wales (AU)

(73) Assignee: The University of Sydney, Sydney (AU)

(21) Appl. No.: 13/223,693

(22) Filed: Sep. 1, 2011

(30) Foreign Application Priority Data
Sep. 1, 2010 (AU) 2010903926

(51) Int. Cl. E21C 41/26; G06K 9/48

(52) U.S. Cl. 299/10; 382/199

(57) ABSTRACT

Described herein is a computerised method for identifying and classifying edges in a dataset representative of an open-pit mine terrain. The method includes the step of identifying one or more surfaces of the terrain having common topological attributes (306). Then, for each surface identified, edges of the identified surface are detected (308) and each of the detected edges are classified (316) as one of a toe, crest, or other than a crest or a toe. The method also includes the step of updating the dataset (208) with the edges classified as toes or crests.

### CLAIM OF PRIORITY

The present patent application claims the priority benefit of the filing date of Australian Patent Application No. 2010903926, filed Sep. 1, 2010, the entire content of which is incorporated herein by reference in its entirety.

### FIELD OF THE INVENTION

The present invention relates to systems and methods for terrain analysis. The invention finds specific application in analysing the terrain of open-pit mines for facilitating open-pit mining operations.

### BACKGROUND OF THE INVENTION

A wide variety of techniques and methods exist for generating data representative of terrain. Many applications, such as machine learning applications, analyse such terrain data to identify various terrain features.

One such application lies in the broad field of mine automation which, generally speaking, deals with automating various mining processes such as surveying, planning, drilling, blasting, excavation, and removal of excavated material. The automation of these processes can lead to increasing both safety and productivity.

An important step in mine automation is the modelling and analysis of the mine terrain. A number of methods exist by which the terrain of a mine may be modelled and data representative of the terrain obtained. These methods range from traditional manual surveying methods to automated computer implemented methods. Once the mine terrain has been modelled, however, it must further be analysed and pertinent terrain features identified. This is a dynamic and ongoing process as the terrain changes during the mining operation.

One set of mine features which are of critical importance in open-pit mines are mine benches. By being able to accurately determine the location of benches in a mine the shape of the mine can determined and future developments of the mine can be planned. Further, knowing the position of benches in an open-pit mine allows the overall pit slope angle to be determined. This is important because if the mine is excavated such that the pit slope angle is too high the pit may collapse. Identification of the benches can also assist in a variety of tasks, such as automated vehicle guidance, drilling and blasting.

### SUMMARY OF THE INVENTION

In one aspect the present invention provides a computerised method for identifying and classifying edges in a dataset representative of an open-pit mine terrain, the method including: identifying one or more surfaces of the terrain having common topological attributes; for each surface identified: detecting edges of the identified surface; and classifying each of the detected edges as one of a toe, crest, or other, and updating the dataset with the edges classified as toes or crests.

In a second aspect the present invention provides a computerised method for identifying and classifying edges in a dataset representative of a terrain, the method including: identifying one or more surfaces of the terrain having common topological attributes; for each surface identified: detecting edges of the identified surface; and classifying each of the detected edges as one of a toe, crest, or other, and updating the dataset with the edges classified as toes or crests.

The common topological attributes by which the one or more surfaces are identified may be selected from a group including gradient and elevation.

Identifying the one or more surfaces of the terrain having common topological attributes may include: calculating surface normal data in respect of a plurality of points of the terrain; and grouping each terrain point into one or more groups based on the surface normal data and a position of the terrain point, each of the one or more groups corresponding to a surface of the terrain.

The surfaces identified in the identification of one or more surfaces of the terrain may be horizontal and substantially horizontal surfaces.

When the dataset is applied to an open-pit mine, the surfaces identified in the identification of one or more surfaces of the terrain may be benches.

Alternatively, when the dataset is representative of an open-pit mine, the surfaces identified in the identification of one or more surfaces of the open-pit mine terrain may be face surfaces of the open-pit mine.

Detecting the edges of each identified surface may include: locating the edges of the identified surface; tracing the edges of the identified surface; and fitting lines to the traced edges of the identified surface.

Classifying a detected edge as one of a toe, crest, or other may include: classifying one or more segments of the edge as one of a toe, crest, or other; and classifying the edge as one of a toe, crest, or other based on a voting strategy with respect to the individual segment classifications.

Classifying an edge segment as one of a toe, crest, or other may include: comparing topological properties of terrain on a first side of the edge segment in the vicinity of the edge segment to topological properties of terrain on a second side of the edge segment in the vicinity of the edge segment, the first and second sides being opposite sides of the edge segment; and, based on the comparison, classifying the edge segment as one of a toe, crest, or other.

The topological properties of terrain on the first side of the edge segment may be obtained from analysis of one or more terrain points located on the first side of the edge segment in the vicinity of the edge segment; and the topological properties of terrain on the second side of the edge segment may be obtained from analysis of one or more terrain points located on the second side of the edge segment in the vicinity of the edge segment.

The topological properties of terrain on the first side of the edge segment may be obtained from analysis of at least two terrain points located on the first side of the edge segment; and the topological properties of terrain on the second side of the edge segment may be obtained from analysis of at least two terrain points located on the second side of the edge.

The topological properties of the terrain on the first and second sides of the edge segment that are compared may be the gradients of the terrain on the first and second sides of the edge segment, and the line segment may be classified as a toe, crest, or other based on the difference between the gradient on the first side of the edge segment and the gradient of the second side of the edge segment.

The terrain gradient at a particular point may be determined by calculating an orthogonal vector at the point.

A support vector machine may be used in classifying each of the detected edges as one of a toe, crest, or other.

The dataset may be obtained by processing raw sensed data of the terrain using Gaussian process terrain estimation methods.

The raw sensed data may include data from a plurality of sensors, and the processing may further include fusing the data from the plurality of sensors together.

The processing of the raw sensed data may further include detecting outliers in the raw sensed data and removing said outliers from the raw data.

Updating the dataset with the edges classified as toes or crests may include incorporating data into the dataset which allows toes and crests to be visually distinguished when the dataset is viewed as a three-dimensional representation of the terrain.

Classification of an edge as other than a toe or crest may include classification of the edge as a peak, a trough, or neither a peak nor a trough.

In a further aspect the present invention provides computer readable instructions executable by a computer processing means to implement the computerised method according to any one of the above statements.

In a still further aspect the present invention provides a computer readable medium storing computer readable instructions described above.

A further aspect of the invention provides a system for identifying and classifying edges in a dataset representative of a terrain, the system including: a processing unit; a memory; and one or more input/output devices, wherein the processing unit is connected with the memory and one or more input output devices by a communications bus, and wherein the memory stores the dataset and instructions executable by the processing unit to: identify one or more surfaces of the terrain having common topological attributes; for each surface identified: detect edges of the identified surface; and classify each of the detected edges as one of a toe, crest, or other, and update the dataset stored in the memory with the edges classified as toes or crests.

In yet a further aspect the present invention provides a method of mining an open-pit mine including: obtaining a dataset representative of the open-pit mine terrain; identifying and classifying edges in the dataset as toes or crests according to the method described above; performing a mining operation at a location based on the location of the toes and crests identified, the mining operation altering the topography of the mine terrain; obtaining an updated dataset representative of the open-pit mine terrain after the performance of the mining operation; and identifying edges in the updated dataset as toes or crests according to the method described above.

The mining operation may include drilling, blasting and excavation.

### BRIEF DESCRIPTION OF THE FIGURES

A preferred embodiment of the invention will now be described with reference to the accompanying Figures in which:

FIG. 1A is a block diagram of a computer system suitable for use with the present invention;

FIG. 1B is a reproduction of a photograph of an open-pit mine;

FIG. 1C shows a schematic elevational cross-section representation of a part of the mine of FIG. 1B;

FIG. 2 is a flow chart outlining the broad steps of the method of an embodiment of the invention;

FIG. 3 is a flow chart showing various sub-steps to those shown in the flow chart of FIG. 2;

FIG. 4A shows an example of a representation of a wall segment of a mine with surface normals marked;

FIG. 4B shows a representation of the clustering of the wall segment of FIG. 4A;

FIGS. 5A to 5D show examples of visual representations of steps in the edge detection and classification process according to an embodiment of the invention;

FIG. 6 shows a depiction of the parameters used in the edge classification method according to an embodiment of the invention;

FIG. 7A shows a representation of the wall segment of FIG. 4A with classification parameters indicated;

FIG. 7B shows a representation of the classification space corresponding to the wall segment of FIG. 4A with edges classified based on the parameters indicated in FIG. 7A;

FIG. 8 shows an example of an estimated terrain map of an open-pit mine;

FIG. 9 depicts the edges identified in the terrain map of FIG. 8;

FIG. 10 shows the edges of FIG. 9 overlain on the terrain map of FIG. 8;

FIG. 11A shows the classification of the edges depicted in FIG. 9 using a method in accordance with the present invention with a linear kernel;

FIG. 11B shows the classification of the edges depicted in FIG. 9 using a method in accordance with the present invention with a polynomial kernel;

FIG. 11C shows the classification of the edges depicted in FIG. 9 using a method in accordance with the present invention with a radial basis kernel; and

FIG. 12 is a flowchart outlining the general steps involved in a method of open-pit mining in accordance with an embodiment of the invention.

### DETAILED DESCRIPTION OF THE EMBODIMENTS

The present invention is primarily directed to a system and method for analysing terrain edges and classifying those edges according to the orientation of the surfaces bounding the edges. This has particularly useful application in identifying toes and crests, which define benches in open-pit mines, and the preferred embodiment of the invention will be described in this context.

### 1. System Overview

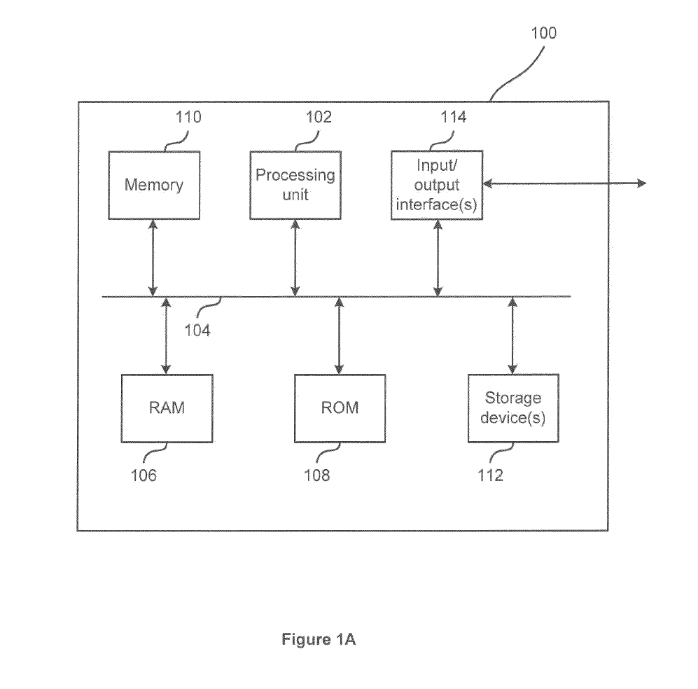

The method of the present invention is a computer implemented method. FIG. 1A is a block diagram of a computing system 100 which may be used to implement the method of the invention.

System 100 includes a processing unit 102 which is in communication with various system components via a system bus 104. The processing unit may include a single processor (with one or more processing cores) or multiple processors. The processors may, for example, be microprocessors, microcontrollers, programmable logic devices or other suitable computational devices. As will be appreciated, a variety of system architectures are possible, and the system may also utilise a group/cluster of remote processing units networked together to provide increased processing capacity.

The system bus 104 may be of any suitable type and use any suitable architecture. For example, the bus may be a memory bus or memory controller, a peripheral bus, or a local bus.

Other system components include memory devices such as one or more random access memory (RAM) devices 106, read only memory (ROM) devices 108, and/or other system memory 110. The ROM devices 108 may include a basic input/output system (BIOS) chip which provides the system 100 with basic functionality (e.g. on system initialisation) in order to access and transfer information between the system components.

The system 100 may also include one or more non-volatile data storage devices 112 which are connected to the bus 104 via a drive interface. These may, for example, include one or more magnetic disc drives, optical disc drives, tape drives, or solid state memory devices. The computer readable media associated with these data storage devices may be used to store computer readable instructions and program data.

The system 100 also includes at least one (typically several) input and output interfaces 114 which allow the system 100 to interface with a variety of input/output devices. These devices may include, for example, keyboards, pointing devices (e.g. mouses), display screens, touch-screens, microphones, speakers, hard disc drives, compact disc drives, digital versatile disc drives, memory card slots (for interfacing with solid state memory cards such as Compact Flash cards, Secure Digital cards, and suchlike), USB ports, Firewire ports, eSata ports, Bluetooth receiver/transmitters, infrared receiver/transmitters etc. The input/output devices may also include a network interface (such as a network card) allowing wired or wireless input/output to the system 100 over a network.

Instructions for controlling the processing unit 102 to perform the method of the invention may be conveyed to the computing system 100 in a variety of ways. For example, the instructions may be loaded to memory 106, 108 or 110 (via the input output interface(s) 106) directly from a computer readable storage medium such as a compact-disc, DVD, solid state memory card or similar. Alternatively, the instructions may be conveyed to the computing system 100 by means of a data signal in a transmission channel communicating with the computing system 100 (again, via the input/output interface(s) 114).

It will be understood that this description of a computing system is only one example of possible systems in which the invention may be implemented. The functions represented by the blocks in FIG. 1A may be provided through shared or dedicated hardware which may further be local or remotely accessed. By way of example, Block 102 is described as a processing unit, however this “unit” may be a single processor or multiple processors (local and/or remote).

The method of the invention will typically be implemented by a computing system processing a sequence of instructions.

### 2. Open-Pit Mine Overview

FIG. 1B is a reproduction of a photo showing typical terrain of an open-pit mine 150. The mine 150 includes a plurality of benches 152 (substantially horizontal surfaces) interconnected by a plurality of faces 154 (inclined surfaces). The lowest bench 152 rises from the mine floor 156 (which may be a local or absolute floor). As can be seen, the mine includes a large number of edges 158, occurring where substantially horizontal surfaces (e.g. benches 152) transition to upwardly or downwardly inclined surfaces (e.g. faces 154).

Throughout this specification the term “bench” will be used to refer to horizontal or substantially horizontal surfaces (which may, for example, include roads and/or mine floors). Similarly, the term “face” will be used to refer to inclined surfaces, or surfaces that are not horizontal or substantially horizontal.

FIG. 1C is a schematic representation showing an elevational cross-section of a series of benches 152 and faces 154 of the mine 150. The edges 158 between benches 152 and faces 154 are either toes 160 (where a bench 152 transitions upwardly to an upper face 154) or crests 162 (where a bench 152 transitions downwardly to a lower face 154). While the benches 152 depicted in FIGS. 1B and 1C are quite distinctive, this is not always the case with benches often being uneven and the toes and crests being poorly defined.

Other relevant features of the mine that will be referred to in this application are the pit slope angle θₛ (reference 164 in FIG. 1C), the bench height h_{b} (the vertical distance between adjacent benches, reference 166 in FIG. 1C), and the bench width h_{w} (the width of a bench between its bounding faces, reference 168 in FIG. 1C).

### 3. Overview

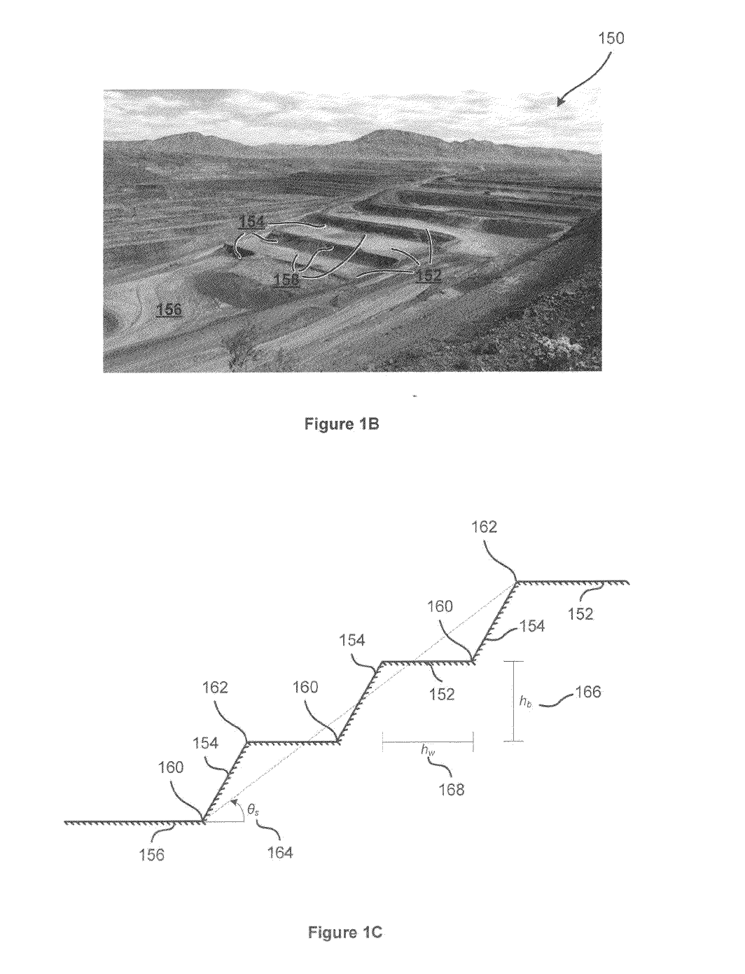

By way of general overview, and referring to flow chart 200 of FIG. 2, in order to classify edges the present embodiment of the invention a dataset representative of a 3D model of the terrain in question is obtained 202 (e.g. an open-pit mine such as that shown in FIG. 1A). Edges in the dataset are identified in step 204 (though, it will be appreciated, the dataset of the terrain may be pre-processed and provided with edges already identified), and then classified in step 206 as either toes, crests or other. Depending on the application of the invention, a classification of an edge as other than a toe or crest may simply include classifying the edge as being neither a toe nor a crest. Alternatively, classification as an edge as other than a toe or a crest may include classifying the edge as a peak or as a trough. In step 208 the dataset is updated (or a new dataset created) to store the classified edges.

Each of these steps will now be described in detail. Following this a real world example will be described by reference to a trial of the method of the invention.

### 4. Terrain Estimation

A number of techniques/processes exist by which a dataset relating to a three-dimensional representation of terrain can be generated. As the present invention is primarily directed to the analysis of data/terrain models after the data has been gathered/processed into a terrain map, these techniques will be described in passing only.

Generally speaking, terrain estimation consists of finding the best estimate of a surface that approximates the true topology of that surface. For each point in the xy-plane of a surface the corresponding height z must be modelled. The given input is one or many point clouds, each point cloud consisting of a number of sensor readings. Each point, q̅ in a point cloud is a point in three dimensions: q̅=(x,y,z), and for each point q̅ the elevation uncertainty, σₙ², is known.

In addition to the below description, systems and methods for analysing and processing large scale terrain data using Gaussian processes can be found in the following PCT applications which are incorporated herein by cross reference: PCT/AU2009/001235 titled A Method of Establishing and Maintaining a Model of Terrain Data, filed on 18 Sep. 2009; PCT/AU2009/001668 titled A Method and system of Data Modelling, filed on 21 Dec. 2009; and PCT/AU2010/000552 titled A Method and System for Data Analysis and Synthesis, filed on 11 May 2010.

a. Data Gathering

Raw data regarding the terrain is gathered by sensors. When working with large scale terrain, sensor limitations and/or topological limitations often render it impossible or impractical to scan the entire terrain at once. As such, terrain data for large scale projects is usually gathered by a number of different scans by a single sensor used at multiple locations and/or different types of sensors used at one or more locations. It can also be advantageous to obtain overlapping readings of terrain (either by the same or different types of sensors), which can then be processed to provide a more accurate estimation of the terrain.

There are, of course, numerous methods for gathering terrain data. In the mining environment data, for example, terrain data may be obtained from a number of relatively sparse but approximately equally spaced GPS points and supplemented with data obtained via a number of laser scans performed in different locations about the mine. Alternative data gathering means are also possible, such as the use of a helicopter equipped with a laser scanner to gather terrain data (as described in S. Buckley, J. Vallet, A. Braathen, and W. Wheeler. Oblique Helicopter-Based Laser Scanning for Digital Terrain Modelling and Visualisation of Geological Outcrops. International Archives of the Photogrammetry, Remote Sensing and Spatial Information Sciences, 37(B4):493-498, 2008) and use of a stereo camera to gather terrain data (as described in F. Perlant. Using Stereo Images for Digital Terrain Modelling. Surveys in Geophysics, 21(2-3):201-207, 2000).

b. Data Processing and Terrain Estimation

Once raw data has been gathered it is processed into a representation of the original terrain. A variety of different methods/approaches for processing the data and estimating the underlying terrain are known.

Two common means for representing digital elevation models (DEM) are grid based methods and triangular irregular network methods. In grid based methods, and generally speaking, a regular grid is formed and at each cell of the grid the height of that cell is stored. Grid based methods of modelling terrain are described, for example, in R. Wack and A. Wimmer. Digital Terrain Models from Airborne Laser Scanner Data—A Grid Based Approach, International Archives of Photogrammetry and Remote Sensing, 35(3):293-296, 2002, and F. Ackermann and K. Kraus. Looking Back and Ahead: Grid Based Digital Terrain Models, available at: http://www.qtbi.net/export/sites/default/GTBiWeb/soporte/descarqas/GridBasedDtmEvolution-en.pdf, as at 31 Aug. 2010.

In triangulated irregular networks terrain surfaces are represented by using lines to connect irregular nodes into non-overlapping triangles. Triangulated irregular network approaches to terrain modelling are described, for example, in J. Leal, S. Scheding, and G. Dissanayake. 3D Mapping: A Stochastic Approach, (Australian Conference on Robotics and Automation, 2001), and T. K. Peucker, R. J. Fowler, J. J. Little, and D. M. Mark. The triangulated irregular network (American Society of Photogrammetry: Digital Terrain Models (DTM) Symposium, St. Louis, Mo., May 9-11, pages 516-540, 1978).

### KD-Tree Generation

In order to assist in the data processing, a KD-tree of the data may be generated. A KD-tree is a binary partitioning tree for storing a number of data points in a k-dimensional space. This is described, for example, in: W. H. Press, S. A. Teukolsky, W. T. Vetterling, and B. P. Flannery. Numerical Recipes in C: The Art of Scientific Computing. Cambridge University Press, Cambridge, Mass., USA, 2nd edition, 1992; and A. Moore. An introductory tutorial on KD-trees. Technical Report 209, Robotics Institute, Carnegie Mellon University, Pittsburgh, Pa., USA, 1991.

As a binary tree, each node of a KD-tree has exactly two children. The KD-tree splits the dataset into two subspaces among a dimension. All data points that have a lower coordinate in the current splitting dimension are assigned to the left sub tree and the rest of data points are stored in the right sub tree. In two dimensions the splitting dimension is usually alternated between the horizontal and the vertical axes.

Construction of the tree involves selecting a pivot element which splitting is done around. One choice for building a balanced tree is an element such that both subspaces contain the same amount of data points after splitting or differs by one in the case of an odd number of points.

The KD-tree allows for efficient search of a nearest neighbour as well as returning all points in the tree within a certain range of a query point. For a nearest neighbour search, the leaf node which contains the target point is first found. Since the nearest neighbour must lie closer than this leaf, parts of the whole tree do not need to be checked.

The total complexity for finding the closest neighbour in a tree with m points becomes P(log m). To find the n nearest neighbours the process can be repeated by always ignoring the previously found closest points until n points are found.

### Data Uncertainties

In addition to processing the data to provide an estimation of the terrain, the raw data may also be processed in order to handle undesirable data elements. For example, regardless of how data relating to the terrain is gathered, it is almost certain that the data will include uncertainties. Such uncertainties may be handled by use of machine learning techniques, and in particular Gaussian Processes. In the field of geostatistics, prediction using Gaussian processes is known under the name Kriging—see, for example, D. D. Cox. Best Unbiased Prediction for Gaussian and Log Gaussian Processes. Lecture Notes-Monograph Series, Vol. 44, The First Erich L. Lehmann Symposium-Optimality, pages 125-132, 2004, and G. Matheron. Principles of geostatistics. Economic Geology, 58:1246-1266, 1963. Gaussian processes specifically dealing with large scale terrain modelling/estimation are described, for example, in S. Vasudevan, F. Ramos, E. Nettleton, and H. Durrant-Whyte. Gaussian Process Modelling of Large-Scale terrain. Journal of Field Robotics, 26(10): 812-840, 2009.

### Outlier Detection

It is also common for raw data to include outliers. This may, for example, be caused by dust or other objects being interpreted by a sensor as terrain. As these outliers interfere with estimation of the terrain and produce unwanted errors, processing the data to remove or minimise their influence is desired. Outliers may be detected using a statistical Z-test. An overview of such tests is described in D. T. Larose. Discovering Knowledge in Data—An Introduction to Data Mining. John Wiley & Sons Inc., Hoboken, N.J., USA, 2005.

For a point where the height is to be estimated, the closest N points are fetched from a KD-tree of the dataset as described above. The mean value x̅ of these points as well as the variance σ² are then calculated. Since the true variance is not known, it must be estimated from the sample. Estimates of the sample mean x̅ and sample variance s² are calculated according to the following equations:

$$\begin{matrix}\overline{x} = \frac{1}{N} {\sum }_{i = n}^{N} {x}_{i} & ( Equation 1 ) \\ {s}^{2} = \frac{1}{N - 1} {\sum }_{i = n}^{N} {( {x}_{i} - \overline{x} )}^{2} & ( Equation 2 )\end{matrix}$$

If the closest points are independent and numerous enough, they can be assumed to be normally distributed according to the central limit theorem. A Z-test can therefore be performed on all points to detect any outliers. A point is discarded if the height is further away than α_{d} standard deviations from the mean:

$$\frac{{x}_{i} - \overline{x}}{s} > {α}_{d} \qquad ( Equation 3 )$$

Experimentation has shown that the following, modified Z-test, is particularly effective where the standard deviation has to be bigger than a threshold β_{d}. This prevents points with a low variance from being removed:

$$\frac{{x}_{i} - \overline{x}}{s} > {α}_{d} ⋂ s > {β}_{d} \qquad ( Equation 4 )$$

α_{d} and β_{d} are thresholds that need to be determined from experimental data.

### Data Fusion

Where data is gathered from different sensors (which may well have different noise parameters) and/or from sensors used in different locations, the various datasets must be fused together. Each point cloud from a single sensor or location is stored in its own KD-tree, along with the noise parameter σₙ for each scanned point.

Using Gaussian processes fusion (described, for example, in S. Vasudevan, F. Ramos, E. Nettleton and H. Durrant-Whyte. Heteroscedastic Gaussian Processes for Data Fusion in Large Scale Terrain Modeling, In: Proc. IEEE Int. Conf. Robotics and Automation (ICRA), Anchorage, USA, 2010), the n_{c} closest points to the current point to be estimated are fetched from each one of the KD-trees. For nₚ point clouds this returns a total of n_{c} nₚ points. From these points, only the n_{c} points closest to the test point are returned to the Gaussian process for use in the estimation process.

The input data used for the toe and crest detection method described herein may represent either the terrain, or the terrain together with surface features (such as buildings and trees). The data may also be unspecified in this regard.

The data format may be a grid format such as an elevation at regularly spaced grid points. However, apart from using grid inputs obtained from Gaussian processes as described above, a variety of other representations for the input data can also be used. For example, the data may be an irregular format where various points (x,y,z) are specified which lie on or near the surface, which may or may not include triangles between the points.

Examples of representations that can be used for the method described herein include grid representations such as a digital-elevation-model (DEM) or a digital-terrain-model (DTM), an irregular triangle format such as a triangulated-irregular-network (TIN), or finite-element-mesh representations. DEM is used where the data represents either the terrain, or the terrain together with surface features. DTM refers to data that represents the terrain only.

Such representations may originate from a variety of data processing methods including at least one of the following, namely Gaussian processes, Kriging, information smoothing, linear interpolation, natural-neighbour interpolation, nearest neighbour interpolation or spline models.

### 5. Edge Processing

From the terrain estimation process a dataset representative of a three-dimensional model of the terrain is obtained. This dataset must then be analysed in order to identify and classify relevant terrain features. As described above, the features relevant to the present invention are edges in the terrain which, in the open-pit mine application of the invention, relate to toes 160 and crests 162.

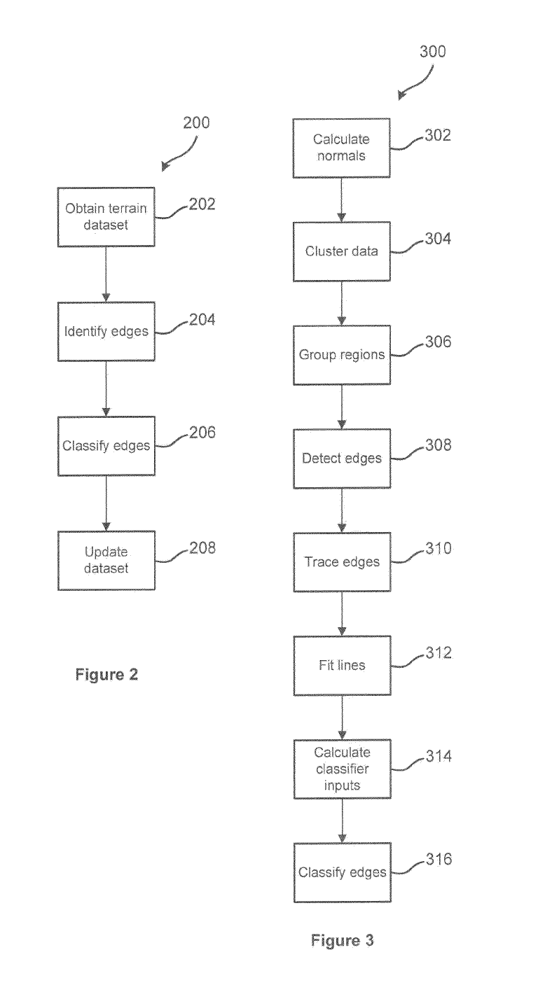

By way of overview, and referring to the flow chart of FIG. 3, edges of the terrain are identified by determining terrain surfaces having common topological attributes from the terrain dataset and identifying the edges of those surfaces. In the embodiment described below, the surfaces selected for extraction/processing are the horizontal/near horizontal surfaces of the terrain—e.g. benches (steps 302, 304, 306). The edges of these surfaces are then identified (steps 308, 310 and 312) and, finally, classified (steps 314 and 316).

It would equally be possible to adapt the method described below to also or alternatively process inclined surfaces (e.g. faces) of the dataset (i.e. by identifying and extracting the inclined surfaces and then identifying the edges of the inclined surfaces).

In a dataset with “perfect” transitions from flat to inclined surfaces the extracted edges of adjacent flat and inclined surfaces would meet, and applying the method to horizontal surfaces would yield the same results as applying the method to inclined surfaces. In reality, however, and with a dataset having less than perfect transitions between adjacent horizontal and inclined surfaces (i.e. a dataset with rough or smooth transitioning edges), the identified edges of adjacent horizontal and inclined surfaces are likely to be slightly offset from each other. In this case a measure of uncertainty of the edge detection process may be obtained by extracting both horizontal and vertical surfaces, detecting the edges of those surfaces, identifying which edges should be the same edge (i.e. the edge of the horizontal surface that should correspond to the edge of the inclined surface), and comparing the relative location of those edges.

a. Surface Extraction

The initial step in identifying the edges in the dataset involves extracting the horizontal or near-horizontal surfaces (e.g. benches 152) from the estimated terrain. This is achieved by a segmentation process in which surface normals for each point in the estimated terrain are calculated (step 302). Points are then clustered together based on their location and surface normals (step 304), and regions are grouped together (step 306).

### Surface Normal Calculation

The terrain dataset (i.e. the output from the terrain estimation process) is a grid in the xy-plane, with each point in the grid having an estimated elevation. In step 302, a location vector p̅ᵢ and a surface normal vector n̅ᵢ are calculated for each point in the grid. Calculation of the surface normal vectors can, for example, be done in Matlab using the built in function “surfnorm”. Alternative methods for calculating the surface normals are, of course, possible.

The surface normal vector and location vector are then stacked to create input vectors v̅ᵢ to the clustering algorithm described below.

v̅ᵢ=[αpₓᵢ,αp_{yi},αp_{zi},βnₓᵢ,βn_{yi},βn_{zi}]^{T}

As the Euclidean norm is used, the relative scale of the components v̅ᵢ of is important and the components of v̅ᵢ are scaled by multiplying the location and surface normal vectors by α and β respectively. Parameters α and β are selected to suit the terrain in question.

### Clustering

In the present embodiment k-means clustering is used due to its relative simplicity and ability to handle large datasets. In k-means clustering, n vectors v̅ᵢ, v̅₂, . . . v̅ₙ are clustered into k clusters C=C₁, C₂, . . . , Cₖ such that the sum of squares of the objects inside each cluster is minimised. The sum to minimise can be written as:

$$SSE = {\sum }_{i = 1}^{k} {\sum }_{\overline{v} ∈ {C}_{i}}^{ } {‖ \overline{v} - {\overline{m}}_{i} ‖}^{2} \qquad ( Equation 5 )$$

Where, mᵢ is the centroid of cluster i, ∥·∥ and is a vector norm (e.g. the Euclidean norm). The algorithm in its whole (sometimes referred to as Lloyd's algorithm), is as follows:

Algorithm 1:
k-means clustering of vectors v̅₁, v̅₂,... v̅ₙ into k clusters

```
1. Randomly select k objects as initial cluster locations and name
      the cluster centres C₁,C₂,...Cₖ
2. repeat
3. for i = 0 to n do
4. Assign object pᵢ to the closest cluster centre
5. end for
6. for i = 0 to k do
7. Calculate centre of cluster Cᵢ by calculating the centroid
              of the assigned objects
8. Update cluster centre Cᵢ to new position
9. end for
10. until cluster centres have not changed
```

The output of the algorithm is k clusters C₁, C₂, . . . Cₖ, with each input vector being assigned to exactly one cluster.

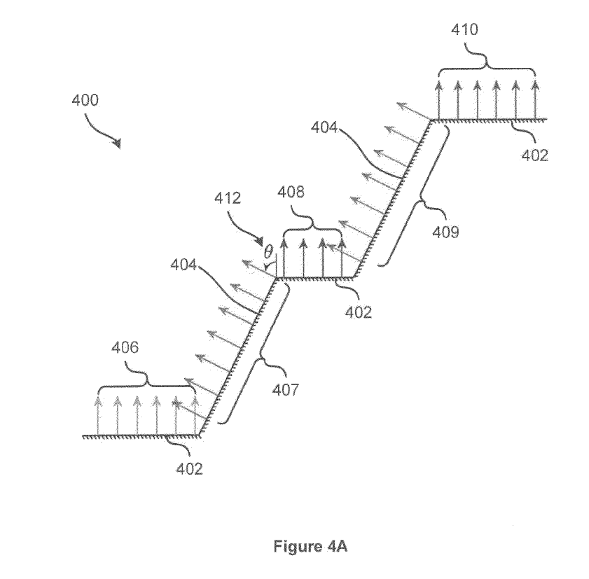

By way of illustration, FIG. 4A provides an idealised representation (in two-dimensions) of a wall segment 400 of a mine region having benches 402 and faces 404. The arrows in arrow groups 406, 407, 408, 409, and 410 illustrate the calculated normals to the surface at various points on each bench 402 and face 404.

FIG. 4B provides a representation of the “cluster space” once the points of the mine wall represented in FIG. 4A have been clustered according to the angle θ (reference numeral 412 in FIG. 4A), representing the angle of the surface normal to a “true” normal (i.e. vertical) and position x. This allows horizontal regions to be identified according to the magnitude of angle θ (with low values indicating horizontal or near-horizontal surfaces).

As can be seen, the clustering process results in a number of clusters of terrain points that have similar terrain inclination and location. For the present purposes only the horizontal/near horizontal surfaces (benches) are of interest since toes and crests are located on the borders of the benches.

### Grouping

For each cluster c the average dot product between the surface normal and the z-axis is calculated to provide angle θ (reference numeral 412 in FIG. 4A):

$${avr}_{c} = \frac{1}{{N}_{c}} {\sum }_{i = 1}^{{N}_{c}} < {\overline{n}}_{i} , \hat{z} > 1 \leq c \leq k \qquad ( Equation 6 )$$

In step 306 regions with a large mean average dot product are extracted by thresholding on the values avr_{c}, and then grouped into a single group and used for detecting the edges. A suitable threshold for this process can be calculated from the inverse cosine of the threshold angle selected. The threshold angle can be determined with reference to measurements, training data from mines, design parameters of mines, or simply experience. By way of example, a typical threshold value of the surface angle for a mine bench (or ramp surface or bottom mine surface) may be 6°—though it is again noted that this parameter will generally be tuned according to the specific application.

b. Edge Detection and Extraction

In steps 308, 310 and 312 the edges of the horizontal regions identified above are detected and extracted. This involves using an edge detection algorithm to detect the edges of the regions (step 308), tracing the edges to discard pixels that have produced large gradient but are not part of an edge line (step 310), and fitting lines to the edges (step 312) for later classification.

Typically, the horizontal regions located are not very smooth. As such, and as an initial step (not illustrated in the flowchart of FIG. 3), a Gaussian filter may be used to smooth the regions and remove missing areas from inside the regions.

### Edge Detection

The edges of the filtered regions are then detected (step 308) using an edge detection method. A wide variety of methods for detecting edges are known. General considerations relating to edge detection and edge detection methods are described, for example, in: D. Marr and E. Hildreth. Theory of Edge Detection. Proceedings of the Royal Society of London. Series B, Biological Sciences, 207(1167):187-217, 1980; T. Peli and D. Malah. A Study of Edge Detection Algorithms. Computer Graphics and Image Processing, 20(1):1-21, September 1982; and R. Jain, R. Kasturi, and B. G. Schunck. Machine Vision. McGraw-Hill, Inc., New York, N.Y., USA, 1995.

A more specific edge detection algorithm, and one that is of use for the purposes of the present invention, is the Canny edge detection process as described in J. Canny. A Computational Approach to Edge Detection. IEEE Transactions on Pattern Analysis and Machine Intelligence, 8(6):679-697, 1986, and S. W. Lee and A. Verri, editors. Pattern Recognition with Support Vector Machines. First International Workshop, SVM 2002, Niagara Falls, Canada, Aug. 10, 2002, Proceedings, volume 2388 of Lecture Notes in Computer Science, 2002. Springer.

The Canny edge detection process locates edges in four different directions to determine the edge gradient and direction. The Canny edge detection process assumes that edges should be a series of continuous pixels.

### Edge Tracing

The output from the Canny edge detection process is a binary image in which possible edge pixels have the value 1 and the other pixels have the value 0. In step 310 an edge tracing algorithm is used to group the possible edge pixels from the image into a number of lists where each list includes edge pixels belonging to a particular edge.

A suitable algorithm for achieving this is as follows:

Algorithm 2:
Edge tracing on binary image M

1: Mark all pixels in M as not visited
2: for every pixel p 2 M do
3: if p not visited and p is edge then
4: Create new neighbour list G
5: Store p in G and mark p as visited
6: while neighbour(p) not visited and neighbour(p) is edge do
7: p ← neighbour(p)
8: Store p in G and mark p as visited
9: end while
10: Output G
11: end if
12: end for

The operator “neighbour(p)” in the above algorithm checks all adjacent pixels to p and returns one neighbour pixel.

In the algorithm, all pixels in the input image are initially marked as ‘not visited’. The input pixels are then looped through and if an edge that is not visited is found, a neighbour list is created and the current pixel is marked as ‘visited’. From the initial pixel, a non-visited edge pixel is located and if found, that pixel is set as the current pixel and added to the list. The next non-visited pixel is then located and the process is repeated until no more pixels can be found and the current neighbour list is returned.

The output of the algorithm is a number of lists with each list containing all pixels that are neighbours and, as such, are interpreted as belonging to the same edge.

### Line Fitting

After the edges are found and traced, lines are fitted in step 312.

The line fitting process involves fitting lines of a minimum length δₗ. Each list of neighbouring pixels that is longer than δₗ is processed by looping through the list and calculating a line between every δₗ coordinates. If the angle between a newly created line segment and the first line segment differs by more than α_{d} degrees, then a new line list is created. This serves to prevent lines being created that contain both crests and toes. A suitable algorithm for this process is as follows:

Algorithm 3:
Fit lines to neighbour lists G₁, G₂, . . . , Gᵣ

1. for i = 1 to r do
2: if length(Gᵢ) ≧ δₗ then
3: Create new line list L
4: for j=1 to length(Gᵢ) − δₗ step δₗ do
5: Create line, l, between element j and j + δₗ in Gᵢ
6: if j == 1 then
7: l_{first} ← l
8: else
9: if angle between l_{first} and l is bigger than α_{d} then
10: Output L
11: Create new line list L
12: Store l in L
13: l_{first} ← l
14: else
15: Store l in L
16: end if
17: end if
18: end for
19: Output L
20: end if
21: end for

A suitable value of α_{d} is 70°. The parameter δₗ can be used to control the smoothness of the fitted lines. δₗ=2, for example, results in lines with short segments that follow an edge closely. The parameter α_{d} dictates how different two line segments must be in order to split the current line list. A large value of α_{d} would result in longer line lists, and a smaller value of α_{d} would result in shorter line lists.

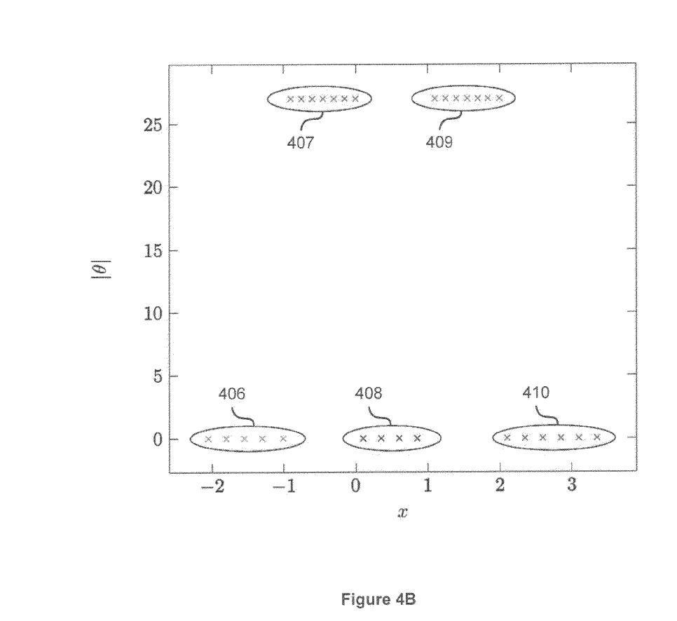

FIGS. 5A to 5C provide an illustration of an example of the edge detection and extraction process described above. In FIG. 5A terrain 500 consisting of 100×100 points is depicted. FIG. 5B provides a representation of the terrain 500 once clustering has been performed and the horizontal areas have been extracted by thresholding on the average dot product between the gradient and z-axis. As can be seen, the horizontal regions 502 and 504 have been detected. The horizontal regions are then smoothed and the edges are detected as described above. Lines representing edges 506 and 508 are then traced and fitted as can be seen in FIG. 5C. As will be appreciated, edges 506 and 508 detected are located in the regions where the toes and crests should be located.

Continuing from the example illustrated in FIGS. 5A to 5C, FIG. 5D provides a representation of the terrain 500 once the edge classification procedure described below has been performed. As can be seen, in FIG. 5D extracted line 506 is classified as a toe (represented in this instance by an unbroken line), and extracted line 508 classified as a crest (represented in this instance by a broken line). As will be appreciated, the present invention may provide alternative means of visually distinguishing between toes and crests, such as line colours, line weights, line patterns, or call-outs.

### Edge Classification

In steps 314 to 316 each of the detected edges (to which lines have been fitted as described above) are classified into one of three classes: toe, crest or other. (As noted above, in alternative embodiments of the invention more than three classes may be used). A classification of other indicates that the edge does not match sufficiently well to a toe or crest—e.g. where the edge is a peak, trough, flat region, a region with a constant slope, an edge with too smooth a transition or similar. While the edge detection process is unlikely to return many edges that are neither toes or crests, some may be returned due to terrain roughness, noise in the dataset, or simply borderline cases. The data points used for classifying an edge to its corresponding class is a five-dimensional vector as described below.

In step 314 the inputs to the classification process are calculated. For each of the line segments in the xy-plane an orthogonal vector l̅_{⊥} is calculated and sampled at least two sample points—at least one sample point being taken from each side of the line segment l. In the present embodiment four sample points are used, with two of the sample points ( p̅₋₂, p̅₋₁) taken from one side of the line segment l, and two (( p̅₂, p̅₁)) taken from the opposite side of the line segment 1.

The points are calculated on the projected xy-plane according to the following equation, where l̅_{end} denotes the end point on line l, and δ is a constant that determines the distance from l that the points are sampled at:

p̅ᵢ= l̅_{end}+iδ l̅⊥ ∀iε{−2,−1,1,2} (Equation 7)

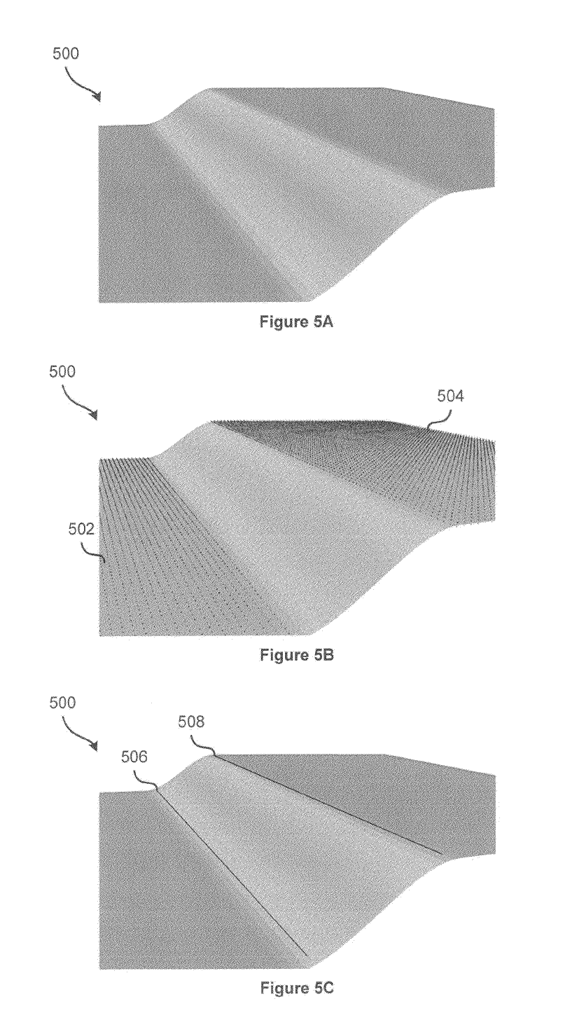

The lines in three-dimensional space between points ( p̅₋₂) and ( p̅₋₁), and between points ( p̅₋₁) and l̅_{end}, are calculated, as are the lines between points ( p̅₂) and ( p̅₁), and between points ( p̅₁) and l̅_{end}. The derivatives, k₋₂, k₋₁, k₁, k₂, of these four lines are also calculated, which, with the uncertainty u at the point l_{end} (from the Gaussian process regression used in estimating the terrain), are the five values used by a classifier to classify the edge. A simple depiction of the lines used for calculating the input to the classifier is shown in FIG. 6 in which l̅_{end} is one point to the traced line segment found at a possible location of a toe or crest.

In step 316 the lines are classified by a line classification process. In this instance a support vector machine (SVM) model is used, the input of the SVM model, being the five values noted above:

t̅[k₋₂,k₋₁,k₁,k₂,u]^{T}

The SVM (described below) is used to independently classify each end of each line segment in a given line list. A voting strategy is then used to classify the whole of each line list as a toe, crest, or other. In the voting strategy the class with the most votes is chosen as the class for that whole list.

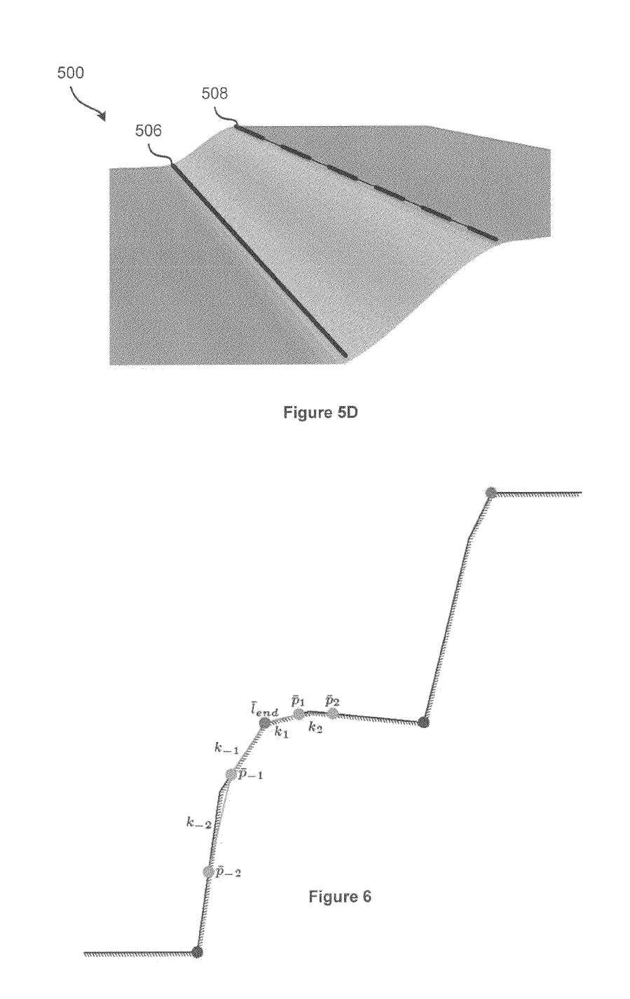

FIGS. 7A and 7B continue the example of FIGS. 4A and 4B, illustrating the use of gradients on either side of detected/traced lines to classify the line as a toe or crest. FIG. 7A shows depicts the gradients s₁ and s₂ on either side of four traced lines A, B, C and D. In FIG. 7B the gradients s₁ and s₂ for each line (A, B, C and D) are plotted against each other in a classification space. In the classification space the toes A and C are separated from the crests B and D, which allows classification of the lines A, B, C, and D. That the toes and crests are separable in the classification space makes it possible to use SVMs to achieve classification of the edges.

FIGS. 7A and 7B (and FIGS. 4A and 4B) show only two dimensions and idealised benches and faces. In a true model (e.g. represented in FIG. 6) there are in fact four slope values and also the u uncertainty value. The separation of the toes and crests in the two-dimensional representation of FIGS. 7A and 7B is equally valid in three-dimensional cases.

### Support Vector Machine (SVM)

By way of general background, SVM's are a supervised learning method used for data classification. A set of training data already classified into a specific class is used for learning of the SVM model, and this model is then used to predict to which class a new value belongs to. By way of example, SVM's can be implemented in C++ or Matlab using the Libsvm library (C. C. Chang and C. J. Lin. LIBSVM: A library for support vector machines, 2001. Software available at http://www.csie.ntu.edu.tw/˜cjlin/libsvm as at 26 Aug. 2010).

The training data consists of a list of input vectors x̅ᵢ of dimensionality D (in this instance, and as noted above, D=5) and belongs to one of two classes yᵢ=+1 or yᵢ=−1. The set of training data is therefore ( x̅ᵢ, yᵢ) where i=1, 2, . . . , L.

If the two classes can be linearly separable, that is if a hyperplane that separates the two groups can be identified, the learning process is to find the two parameters w̅ and b such that:

x̅ᵢ· w̅+b≧+1 for yᵢ=+1 (Equation 8)

x̅ᵢ· w̅+≦−1 for yᵢ=−1 (Equation 9)

These two equations can be combined into:

yᵢ( x̅ᵢ· w̅+b)−1≧0 ∀i (Equation 10)

This corresponds to finding the hyperplane which maximizes the distance to the nearest points on each side of the plane. Equation 10 is equivalent to solving the following optimization problem:

min ∥ w̅∥

subject to yᵢ( x̅ᵢ· w̅+b)−1≧0 ∀i (Equation 11)

Lagrange relaxation and removal of the square root in the calculation of the norm in Equation 11 gives the following optimization problem that can be solved by standard Quadratic Programming:

$${max}_{a} {\sum }_{i = 1}^{L} {α}_{i} - \frac{1}{2} {\sum }_{i , j = 1}^{L} {y}_{i} {y}_{j} {α}_{i} {α}_{j} ( {\overline{x}}_{i} \cdot {\overline{x}}_{j} ) \\ subject to {\sum }_{i = 1}^{L} {y}_{i} {α}_{i} = 0 \\ {α}_{i} \geq 0 ∀ i \qquad ( Equation 12 )$$

To classify an unknown vector x̅′̅ into one of the two classes y′, a decision function is used. b and w̅ must however first be found. For b, the set S for which αᵢ>0 is used in the calculations:

$$\begin{matrix}\overline{w} = {\sum }_{i = 1}^{L} {α}_{i} {y}_{i} {\overline{x}}_{i} & ( Equation 13 ) \\ b = \frac{1}{{N}_{s}} {\sum }_{s ∈ S}^{ } ( {y}_{s} - {\sum }_{m ∈ S}^{ } {α}_{m} {y}_{m} ( {\overline{x}}_{m} \cdot {\overline{x}}_{s} ) ) & ( Equation 14 ) \\ {y}^{′} = sgn ( \overline{w} \cdot {\overline{x}}^{′} + b ) & ( Equation 15 )\end{matrix}$$

This approach results in a linear classifier, but by performing a kernel manipulation it is possible to create non-linear classifiers. The dot-product x̅ᵢ, x̅ⱼ in equation 12 can be replaced by a general kernel function k( x̅ᵢ, x̅ⱼ). In this way the kernel can be changed to give the classifier other properties.

In the case where the original problem is not linearly separable, it is possible to allow for some misclassification of data by introducing slack variables into equations 8 and 9 to provide:

x̅ᵢ· x̅+b≧+1−ξᵢ for yᵢ=+1

x̅ᵢ· x̅+b≦−1+ξᵢ for yᵢ=−1 (Equation 16)

ξᵢ≦0 ∀i

By introducing slack-variables and a kernel function, the optimization problem turns into the following, where C is an arbitrary parameter that controls the number of training errors allowed:

$${max}_{a} {\sum }_{i = 1}^{L} {α}_{i} - \frac{1}{2} {\sum }_{i , j = 1}^{L} {y}_{i} {y}_{j} {α}_{i} {α}_{j} k ( {\overline{x}}_{i} , {\overline{x}}_{j} ) \\ subject to {\sum }_{i = 1}^{L} {y}_{i} {α}_{i} = 0 \\ 0 \leq {α}_{i} \leq C ∀ i \qquad ( Equation 17 )$$

A number of different kernel functions can be chosen, for example:
Linear kernel: k( x̅ᵢ, x̅ⱼ)= x̅ᵢ· x̅ⱼ
Polynomial kernel: k( x̅ᵢ, x̅ⱼ)=(γ x̅ᵢ^{T} x̅ⱼ+r)^{d}
Radial basis kernel: k( x̅ᵢ, x̅ⱼ)=exp(−γ∥ x̅ᵢ− x̅ⱼ∥²), γ>0
Sigmoid kernel: k( x̅ᵢ, x̅ⱼ)=tan h(γ x̅ᵢ^{T} x̅ⱼ+r)

The classification process described above classifies data into one of two different classes. In order to support classification into one of multiple classes the process is modified. This may be achieved, for example, by use of a one-against-one strategy described, for example, in C. W. Hsu and C. J. Lin. A Comparison of Methods for Multiclass Support Vector Machines. IEEE Transactions on Neural Networks, 13(2):415-425, 2002. In a one-against-one strategy k(k−1)/2 classifiers are constructed, where k is the number of classes and each classifier is trained on data from two different classes.

When predicting in which class an unknown vector x̅′̅, belongs, x̅′̅ is tested against all classifiers and a voting strategy is used. Each classifier assigns the vector to one of the two classes it is trained with, m and n. If the classifier finds x̅′̅ belongs to class m, then the vote of m is increased by one. Otherwise the vote of class n is increased. After all classifiers are done, then x̅′̅ is predicted to be in the class with the highest number of votes.

An alternative method for classifying into one of multiple classes is the one-versus-all method. This method constructs k classifiers and the ith model is trained with the data from class i as positive matches and all other data as negative matches. An unknown vector is assigned to the class that outputs the highest value from the decision function in equation 15 above.

### 6. Real World Example

In a trial of the invention terrain data from an open-pit mine was gathered using a laser scanner and a GPS receiver. The laser scanner used was a RIEGL LMS-Z620 providing measurements from 2 metres up to a range of 2000 metres with an accuracy of 10 millimetres, with a vertical scanning range from 0° to 80°, and an angular resolution of 0.002°.

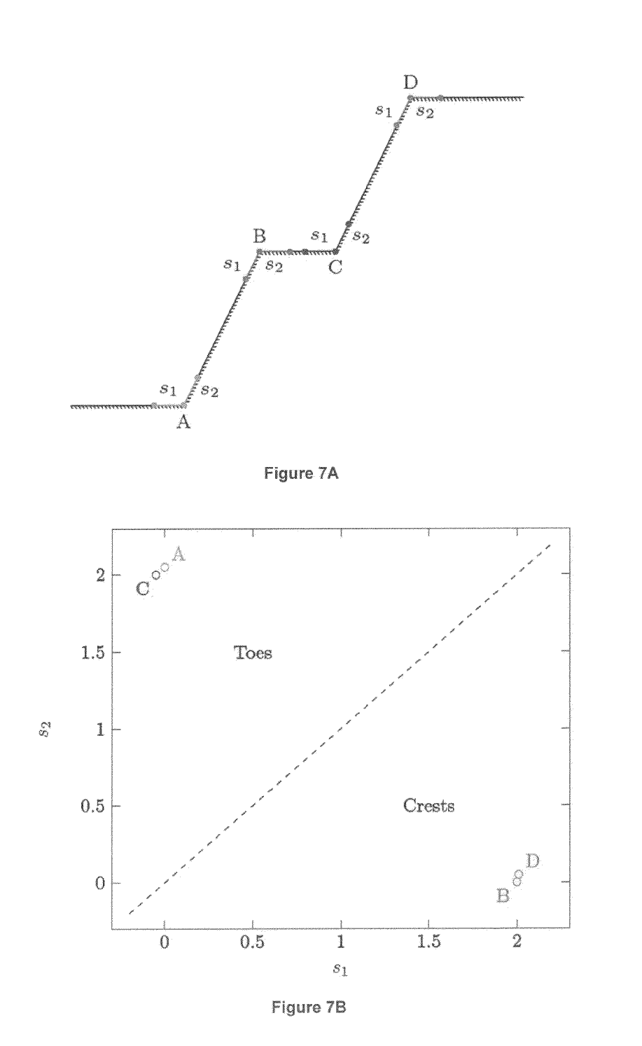

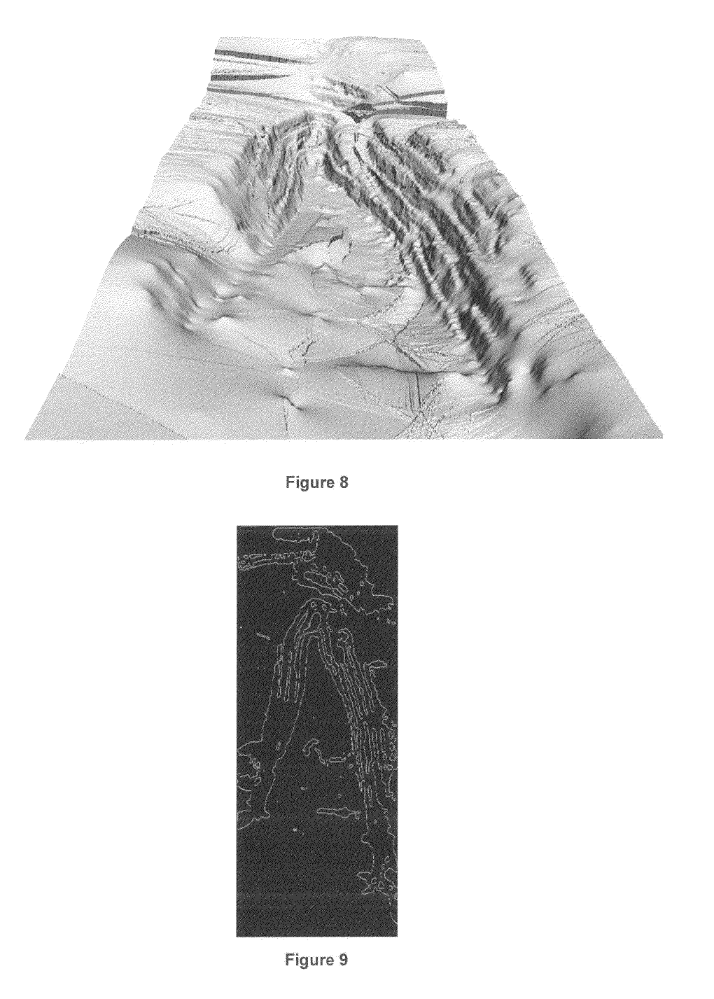

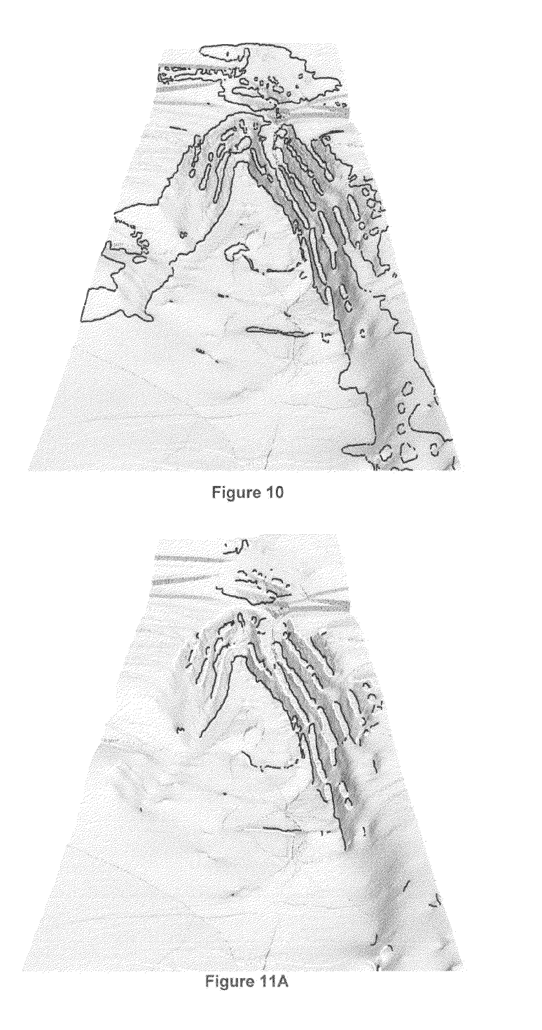

Using terrain estimation methods the gathered dataset was used to estimate a model of the mine as shown in FIG. 8. Clustering and extraction of regions was performed and then the edges located as described above. FIG. 9 shows the detected edges. Line segments were then traced from the edges and the result overlaid on the previously estimated surface, as shown in FIG. 10.

To test the classification of the detected lines, a number of random lines were first classified manually as either crests, toes, or neither. This resulted in training data (1174 five-dimensional vectors) that the SVM was trained on. 10 fold cross-validation with different parameters iterated through was performed during training to estimate the parameters. 10 fold cross-validation is a procedure for validating the training of an optimised or adapted model involving splitting a large dataset into equal groups (in this specific instance 10 groups). For each group X, the training process is optimised based on all the other groups and is tested on the group X. The success/failure counts are summed over all the tests. This aims to prevent ‘over fitting’, which is where the algorithm follows the training data too literally. Without cross-validation, the algorithm can ‘cheat’ by storing the exact correct answer to each training point and using these in the test.

The parameters with the best cross validation fit were selected for use on the whole dataset.

Three kernel functions were then evaluated: a linear kernel, a polynomial kernel of degree 3, and a radial basis kernel. The results of these kernel functions are as follows:

| Kernel | 10-cross validation (%) | Training data fit (%) |
|---|---|---|
| Linear | 87.9 | 88.2 |
| Polynomial | 92.4 | 94.5 |
| Radial basis | 95.7 | 98.7 |

The radial basis kernel gives a very good performance on the training data with a 96% cross validation fit. Classifying the training data using the model shows that nearly 99% of the vectors are correctly classified. The polynomial and linear kernels also give good performance with 92% and 88% cross validation fit respectively.

The confusion matrix from the cross validation of the training data using a liner kernel is as follows:

| | | Predicted | | |
|---|---|---|---|---|
| | | Neither | Crest | Toe |
| Actual | Neither | 337 | 55 | 12 |
| | Crest | 43 | 212 | 19 |
| | Toe | 9 | 4 | 483 |

The confusion matrix from the cross validation of the training data using a radial basis kernel is as follows:

| | | Predicted | | |
|---|---|---|---|---|
| | | Neither | Crest | Toe |
| Actual | Neither | 387 | 14 | 3 |
| | Crest | 16 | 251 | 7 |
| | Toe | 2 | 8 | 486 |

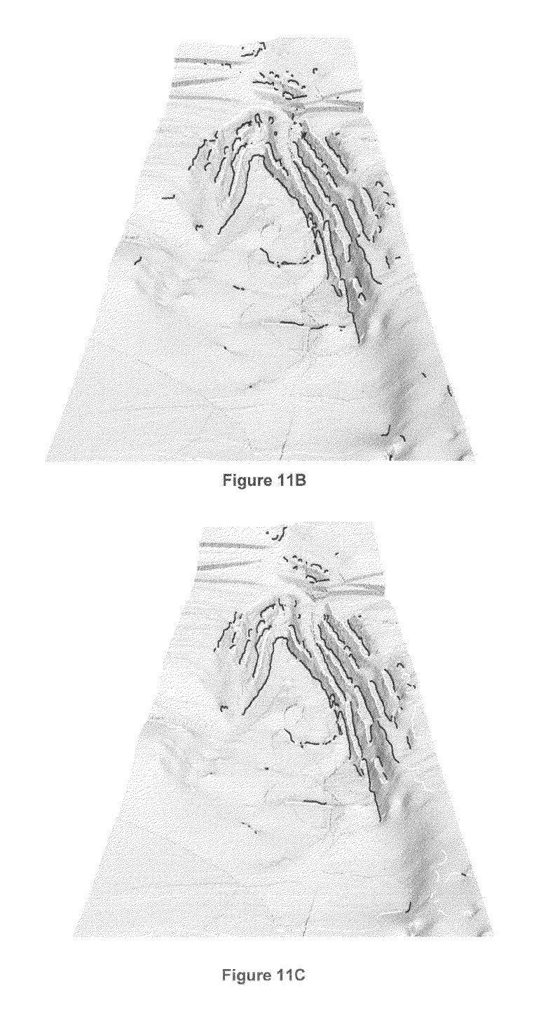

FIGS. 11A, 11B and 11C show the output of the trained model when classifying the whole dataset using different kernels. FIG. 11A shows the output when using a linear kernel, FIG. 11B shows the output when using a polynomial kernel, and FIG. 11C shows the output when radial basis kernel. In FIGS. 11A to 11C toes are indicated by black lines and crests by white lines. As can be seen the performance of all three kernels was similar, all providing good results in which most crests and toes in the terrain were correctly identified.

In other trials, terrain data has been gathered by a vehicle (e.g. a car) fitted with a laser scanner and GPS as described above, along with an inertial measurement unit (IMU). Specifically, an Applanix POS MV V4 IMU was used that provides position, heading, velocity and acceleration together with a metric to evaluate performance. It is equipped with two GPS antennas to allow estimation of the current direction based on the phase difference in the received signals down to an accuracy of 0.02°. A mobile base station was also used together with the IMU to enable real time kinematics (RTK). RTK is a technique to increase the accuracy for GPS devices by using the satellites' carrier instead of the messages contained in them as the signal. This makes it possible to determine the relative position of the GPS device to the base station very accurately, usually down to centimetre level. If the base station is in a known surveyed position then the global position measured will also be very accurate.

### 7. A Method of Mining

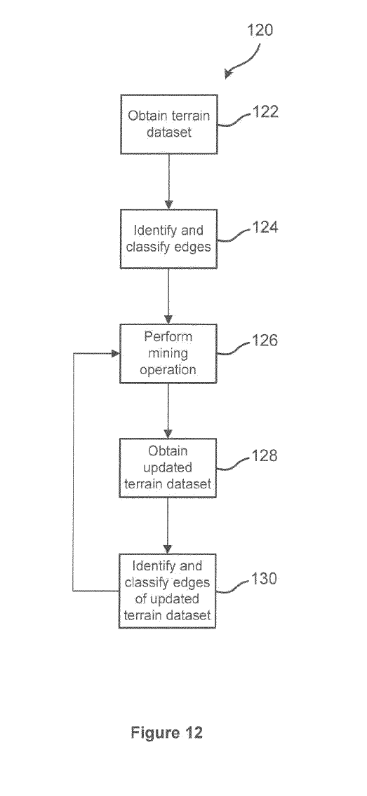

As will be appreciated, the method as described above may be used in a variety of applications. By way of example, one such application of the invention includes a method of open-pit mining as generally outlined in flow chart 120 of FIG. 12.

The method of open-pit mining includes obtaining a dataset representative of the open pit mine (step 122). This dataset may be generated in accordance with the terrain estimation methods described above, or may be obtained by any other appropriate means.

In step 124 the edges in the dataset are identified and classified as toes or crests. The identification and classification of the edges is achieved according to the process described above.

In step 126, one or more mining operations are performed at locations determined by reference to the locations of the toes and crests identified in the dataset. The mining operation may, for example, be an operation that alters the topography of the mine by drilling, blasting, and excavation of the terrain.

In step 128, an updated dataset representative of the open-pit mine terrain after the performance of the mining operation is obtained. Once again, this updated dataset may be generated using the terrain estimation techniques described herein, or by other appropriate means.

In step 130, the edges in the updated dataset are identified and classified as toes or crests (again according to the methodology described above), thereby giving an up-to-date representation of the open-pit mine.

Steps 126 to 130 may, of course, be repeated for any number of mining operations.

The mining operation may be performed in an automatic or autonomous fashion. The term “automatic” refers to a system or process that executes a specific well-defined task that is often narrowly defined. “Automatic” implies following a set of well-defined rules and reacting in a defined way to a defined stimulus. “Automated systems” are those that have some automatic components or properties.

The term “autonomous” refers to systems that are more complex as the systems are able to respond to unknown stimuli and can function without a complete knowledge of their environments. Typically, an autonomous system does not require human intervention to respond to at least some unpredicted changes in its environment. Examples include self-guided and operated vehicles.

Open pit mining, for example of metal-bearing mineral or rock, normally involves the progressive accessing of an ore body followed by drilling, blasting, and loading and haulage of the released material. Each of these operations may be performed in the method 120, using the described techniques for identifying and classifying edges in the open pit. Iron ore, for example, is mined in large blocks from a series of benches and the various mining activities 126 (other than blasting) may be performed concurrently, resulting in diverse equipment, and often personnel, being present simultaneously in the mine site. A bench of ore typically 40 m long×20 m deep×10 m high and containing in the order of 8 kilotonnes of ore is first drilled to form a pattern of blast holes and the drilling residue is analysed, as one step in a more extensive analysis, to determine whether the material to be blasted comprises, on average, high grade ore, low grade ore or waste material. The blasted material is collected by shovels, excavators and/or front end haul loaders, loaded into haul trucks and transported from the mine pit. The material is then processed outside the mine pit.

One or more drilling units may be used to drill the pattern of blast holes. The drilling units may operate autonomously and may be controlled by control units located on the drilling units or in distributed systems. Relevant mining operations include planning the pattern of blast hole locations, planning trajectories of the drilling units to reach the blast hole locations, positioning the drilling units at the locations and controlling the drill operation. These operations generally require the fusion of a large amount of heterogeneous information about the terrain, including the identification and classification of edges as described herein. Suitable methods and systems for exploiting information from heterogeneous sources may be found in WO 2009/109007, filed on 4 Mar. 2009, which is incorporated herein by reference.

Mobile charging units may be used in the processes of loading and stemming drill holes with the correct mix of explosives.

Face inspection units may also move through the open pit to obtain geometrical and geological information about the site. The face inspection units may, for example, be autonomous mobile sensor stations. Real-time mobile assay units may also operate in the open pit. In some arrangements autonomous real-time survey units may operate in the mine site to provide geometric models of the mine in a time frame that is useful for planning and platform automation.

Shovels, including automated shovel units, may be used to excavate material from the open pit. Information about the terrain may be used in the automated control of the shovels, and may also be used to augment the perception of a human shovel operator. For example, a heads-up display may assist an operator in monitoring the site through dust or rain. Trucks may be used to remove the excavated material.

The drilling units, charging units, shovels, trucks, face inspection units, assay units and real-time survey units may all interact with a fused model of the mine terrain that includes edge information derived from the methods described herein. The units may be controlled or supervised by an integrated automation system such as that described in PCT/AU2010/000494, filed on 30 Apr. 2010, the contents of which are incorporated herein by cross reference.

It will be understood that the invention disclosed and defined in this specification extends to all alternative combinations of two or more of the individual features mentioned or evident from the text or drawings. All of these different combinations constitute various alternative aspects of the invention.

1. A computerised method for identifying and classifying edges in a dataset representative of an open-pit mine terrain, the method including:
identifying one or more surfaces of the terrain having common topological attributes;
for each surface identified:
detecting edges of the identified surface; and
classifying each of the detected edges as one of a toe, crest, or other than a crest or a toe, and
updating the dataset with the edges classified as toes or crests.

2. A computerised method according to claim 1, wherein the common topological attributes by which the one or more surfaces are identified are selected from a group including gradient and elevation.

3. A computerised method according to claim 1, wherein identifying the one or more surfaces of the terrain having common topological attributes includes:
calculating surface normal data in respect of a plurality of points of the terrain; and
grouping each terrain point into one or more groups based on the surface normal data and a position of the terrain point, each of the one or more groups corresponding to a surface of the terrain.

4. A computerised method according to claim 1, wherein the surfaces identified in the identification of one or more surfaces of the terrain are horizontal and substantially horizontal surfaces.

5. A computerised method according to claim 1, wherein the surfaces identified in the identification of one or more surfaces of the terrain are benches.

6. A computerised method according to claim 1, wherein the surfaces identified in the identification of one or more surfaces of the terrain are face surfaces of the terrain.

7. A computerised method according to claim 1, wherein detecting the edges of each identified surface includes:
locating the edges of the identified surface;
tracing the edges of the identified surface; and
fitting lines to the traced edges of the identified surface.

8. A computerised method according to claim 1, wherein classifying a detected edge as one of a toe, crest, or other includes:
classifying one or more segments of the edge as one of a toe, crest, or other than a toe or a crest; and
classifying the edge as one of a toe, crest, or other than a toe or a crest based on a voting strategy with respect to the individual segment classifications.

9. A computerised method according to claim 8, wherein classifying an edge segment as one of a toe, crest, or other than a toe or crest includes:
comparing topological properties of terrain on a first side of the edge segment in the vicinity of the edge segment to topological properties of terrain on a second side of the edge segment in the vicinity of the edge segment, the first and second sides being opposite sides of the edge segment; and
based on the comparison classifying the edge segment as one of a toe, crest, or other than a toe or a crest.

10. A computerised method according to claim 9, wherein:
the topological properties of terrain on the first side of the edge segment are obtained from analysis of one or more terrain points located on the first side of the edge segment in the vicinity of the edge segment; and
the topological properties of terrain on the second side of the edge segment are obtained from analysis of one or more terrain points located on the second side of the edge segment in the vicinity of the edge segment.

11. A computerised method according to claim 10, wherein:
the topological properties of terrain on the first side of the edge segment are obtained from analysis of at least two terrain points located on the first side of the edge segment; and
the topological properties of terrain on the second side of the edge segment are obtained from analysis of at least two terrain points located on the second side of the edge.

12. A computerised method according to claim 9, wherein:
the topological properties of the terrain on the first and second sides of the edge segment that are compared are the gradients of the terrain on the first and second sides of the edge segment, and wherein
the line segment is classified as a toe, crest, or other than a toe or a crest based on a difference between the gradient on the first side of the edge segment and the gradient of the second side of the edge segment.

13. A computerised method according to claim 12, wherein the terrain gradient at a particular point is determined by calculating an orthogonal vector at the point.

14. A computerised method according to claim 1, wherein a support vector machine is used in classifying each of the detected edges as one of a toe, crest, or other than a toe or a crest.

15. A computerised method according to claim 1, wherein the dataset representative of the open-pit mine terrain is obtained by processing raw sensed data of the open-pit mine using at least one of the following methods, namely: Gaussian process terrain estimation, Kriging, information smoothing, linear interpolation, natural-neighbour interpolation, nearest neighbour interpolation, and spline models.

16. A computerised method according to claim 15, wherein the raw sensed data includes data from a plurality of sensors, and the processing further includes fusing the data from the plurality of sensors together.

17. A computerised method according to claim 15, wherein the processing of the raw sensed data further includes detecting outliers in the raw sensed data and removing said outliers from the raw data.

18. A computerised method according to claim 1, wherein updating the dataset with the edges classified as toes or crests includes incorporating data into the dataset which allows toes and crests to be visually distinguished when the dataset is viewed as a three-dimensional representation of the terrain.

19. A computerised method according to claim 1, wherein classification of an edge as other than a toe or crest includes classification of the edge as a peak, a trough, or neither a peak nor a trough.

20. A computerised method according to claim 1 wherein the dataset is representative of at least one of: a grid representation, a triangulated-irregular-network and a finite-element-mesh.

21. A computerised method according to claim 20 wherein the grid representation comprises at least one of: a digital-elevation-model and a digital-terrain-model.

22. Computer readable instructions executable by a computer processing means to implement the computerised method according to claim 1.

23. A computer readable medium storing computer readable instructions according to claim 22.

24. A method of mining an open-pit mine including:
obtaining a dataset representative of the open-pit mine terrain;
identifying and classifying edges in the dataset as toes or crests according to the method of claim 1;
performing a mining operation at a location based on the location of the toes and crests identified, the mining operation altering the topography of the terrain of the open-pit mine;
obtaining an updated dataset representative of the open-pit mine terrain after the performance of the mining operation; and
identifying edges in the updated dataset as toes or crests according to the method of claim 1.

25. A method of mining an open-pit mine according to claim 24, wherein the mining operation includes drilling, blasting, and excavation.

26. A system for identifying and classifying edges in a dataset representative of an open-pit mine terrain, the system including:
hardware including:
a processing unit;
a memory; and
one or more input/output devices, wherein
the processing unit is connected with the memory and one or more input output devices by a communications bus, and wherein
the memory stores the dataset and instructions executable by the processing unit to:
identify one or more surfaces of the terrain having common topological attributes;
for each surface identified:
detect edges of the identified surface; and
classify each of the detected edges as one of a toe, crest, or other than a toe or a crest, and
update the dataset stored in the memory with the edges classified as toes or crests.
